(19) United States
(12) Patent Application Publication
(10) Pub. No.: US 2024/0069225 A1
(43) Pub. Date: Feb. 29, 2024

(54) COMPUTER-AUTOMATED METHOD TO CONVERT SEISMIC DATA FILES

(71) Applicant: SAUDI ARABIAN OIL COMPANY, Dhahran (SA)

(72) Inventors: Abdulrahman A. Qarni, Khobar (SA); Nasir H. Harith, Dammam (SA); Baqar Najeeb, Dhahran (SA); Deng Liangyuan, Dhahran (SA)

(73) Assignee: SAUDI ARABIAN OIL COMPANY, Dhahran (SA)

(21) Appl. No.: 17/822,743

(22) Filed: Aug. 26, 2022

(51) Int. Cl. G01V 1/24; E21B 47/0224; G01V 1/30; G01V 1/34

(52) U.S. Cl. CPC G01V 1/247; E21B 47/0224; G01V 1/301; G01V 1/34

(57) ABSTRACT

Systems and methods are disclosed. The method includes determining first metadata for a first seismic data file from a first database, generating a control file using the first metadata, and converting the first seismic data file in a predetermined file format to a destination file format using the control file. The first metadata comprises first values of a first plurality of seismic survey geometry parameters. The method further includes storing a first metadata file in a second database, wherein the first metadata file comprises the first metadata, and storing the first seismic data file in the destination file format in the second database. The method still further includes determining whether the first values of the first plurality of seismic survey geometry parameters duplicate second values of the first plurality of seismic survey geometry parameters.

### BACKGROUND

One or more seismic surveys may be performed to characterize subterranean features and, ideally, identify one or more hydrocarbon reservoirs within a subterranean region. Each seismic survey may record seismic traces and ancillary data that are stored in a digital seismic data file. A seismic data file may be hundreds of gigabytes to tens of terabytes in size. However, the seismic data file may not be immediately loaded into seismic interpretation software because the software requires the seismic data file to be in an alternate file format. Conversion to an alternate file format may be time consuming and prone to error due to the size of a seismic data file and the manual manipulation of a seismic data file before and after conversion.

Multiple seismic data files may exist for the same subterranean region or a portion of the same subterranean region. Loading multiple seismic data files into the seismic interpretation software may be necessary to ensure all relevant seismic data files are used when characterizing the subterranean features of the subterranean region. As such, a data file format manager may be crucial to the oil and gas industry to ensure all relevant seismic data files are properly converted and used.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes determining first metadata for a first seismic data file from a first database, generating a control file using the first metadata, and converting the first seismic data file in a predetermined file format to a destination file format using the control file. The first metadata comprises first values of a first plurality of seismic survey geometry parameters. The method further includes storing a first metadata file in a second database, wherein the first metadata file comprises the first metadata, and storing the first seismic data file in the destination file format in the second database. The method still further includes determining whether the first values of the first plurality of seismic survey geometry parameters duplicate second values of the first plurality of seismic survey geometry parameters.

In general, in one aspect, embodiments relate to a system. The system includes a data file format manager comprising a computer processor. The data file format manager is configured to determine first metadata for a first seismic data file from a first database, generate a control file using the first metadata, and convert the first seismic data file in a predetermined file format to a destination file format using the control file. The data file format manager is further configured to store a first metadata file in a second database, wherein the first metadata file comprises the first metadata, and store the first seismic data file in the destination file format in the second database. The data file format manager is still further configured to determine whether the first values of the first plurality of seismic survey geometry parameters duplicate second values of the first plurality of seismic survey geometry parameters.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic surveying system in accordance with one or more embodiments.

FIG. 2 depicts a computing environment in accordance with one or more embodiments.

FIG. 3 shows a first flowchart in accordance with one or more embodiments.

FIG. 4 shows a second flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a destination file format” includes reference to one or more of such file formats.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the method may be omitted, repeated, and/or performed in a different order than the order shown. Accordingly, the scope disclosed herein should not be considered limited to the specific arrangement of steps shown in the method.

Although multiple dependent claims are not introduced, it would be apparent to one of ordinary skill that the subject matter of the dependent claims of one or more embodiments may be combined with other dependent claims.

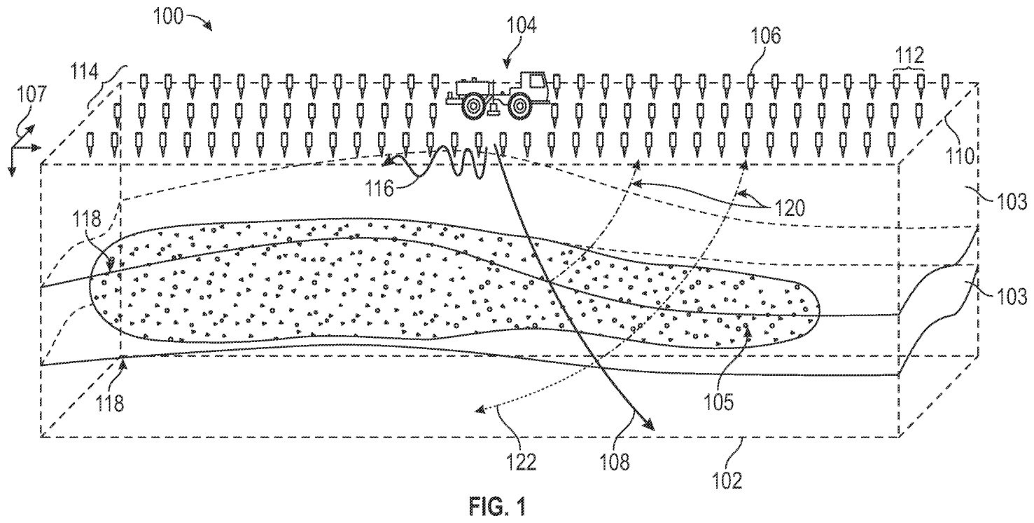

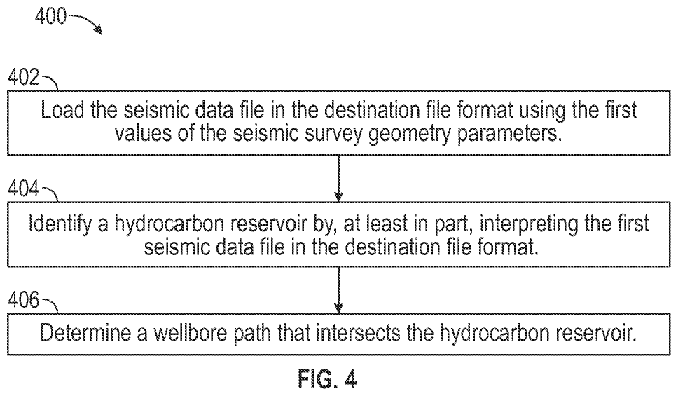

In the following description of FIGS. 1-4, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Systems and methods are disclosed to automatically convert a seismic data file from one file format to another file format. Systems include a data file format manager to automatically manage file format conversion. The method may remove most-to-all manual steps to reduce error.

FIG. 1 depicts a seismic surveying system (100) used to generate and record data stored in a digital seismic data file for a subterranean region of interest (102) in accordance with one or more embodiments. The subterranean region of interest (102) contains layers of rock (103) separated by geological discontinuities (118). Further, the subterranean region of interest (102) may contain a hydrocarbon reservoir (105). The geological discontinuities (118), layers of rock (103), and the hydrocarbon reservoir (105) may be generically referred to as “subterranean features.”

The seismic survey may be associated with a global coordinate reference system. For example, the global coordinate reference system may be a Universal Transverse Mercator (UTM) coordinate reference system (hereinafter “UTM zone”) based on where on the earth the seismic survey is performed. The seismic survey may also be associated with a local coordinate system (107). The local coordinate system (107) may be defined by three orthogonal axes where a first axis is vertically downwards, and an in-line axis and a crossline axis are horizontal axes, orthogonal to the first axis and to each other. The seismic survey may span minimum and maximum values along the first axis, in-line axis, and crossline axis. The local coordinate system (107) may match the UTM zone following a series of translations and/or rotations.

The seismic surveying system (100) includes a seismic source (104) and seismic receivers (106). The position of the seismic source (104) and each seismic receiver (106) may be known relative to the UTM zone and/or the local coordinate system (107). For example, the local coordinate system (107) may be used to define an in-line interval (112) and crossline interval (114) which describes the spacing of seismic receivers (106) along the in-line axis and crossline axis, respectively. In a land environment, the seismic source (104) may be a dynamite source or one or more seismic vibrators (“vibroseis truck”). In a marine or lacustrine environment, the seismic source (104) may be an air gun. A single activation of the seismic source (104) generates radiated seismic waves (108).

The radiated seismic waves (108) may take a variety of paths. Some radiated seismic waves (108) may propagate along the surface of the earth (110) as “surface waves” (116) (alternatively “ground-roll”). Types of surface waves (116) include Rayleigh waves and Love waves. Some radiated seismic waves (108) may reflect (and possibly refract) at geological discontinuities (118) and return to the surface of the earth (110) as reflected seismic waves (120). Still some radiated seismic waves (108) may refract (and possibly reflect) at geological discontinuities (118) and continue towards the center of the earth as refracted seismic waves (122).

Tens of thousands to hundreds of thousands of seismic receivers (106) may detect and record the radiated seismic waves (108), reflected seismic waves (120), and refracted seismic waves (122) over time. Hereinafter, radiated seismic waves (108), reflected seismic waves (120), and refracted seismic waves (122) are collectively referred to as “seismic waves.” In a land environment, the seismic receivers (106) may detect and record the velocity or acceleration of ground motion causes by the seismic waves. In a marine or lacustrine environment, seismic receivers (106) may detect and record pressure fluctuations caused by the seismic waves.

Each seismic receiver (106) records seismic waves as a time series representing the amplitude of ground motion or pressure fluctuations at a sequence of discrete times. Each time series is denoted a “seismic trace.” The number of discrete times depends on a predetermined sampling rate. The seismic traces recorded for all activations of a seismic source (104) and recorded by all seismic receivers (106) are stored in a digital seismic data file (hereinafter “seismic data file”). Ancillary data may also be stored in the seismic data file such as depth, velocity, electromagnetic, gravity, and/or rotational sensor data.

Hereinafter, “seismic survey geometry parameters” associated with a seismic survey may include, but are not limited to, the UTM zone, the local coordinate system (107), minimums and maximums of axes in the UTM zone and/or the local coordinate system (107), position of the seismic source (104), position of the seismic receivers (106), in-line interval (112), crossline interval (114), the number of seismic traces recorded, and sampling rate. Further, seismic survey geometry parameters may be considered “metadata,” which will be further discussed later.

Thus, the seismic data file may store seismic traces organized according to seismic survey geometry parameters. Further, the seismic data file stores seismic traces in a “predetermined file format.” The predetermined file format is commonly an SEG-Y file format or, sometimes, an SEG-D file format, among others. The SEG-Y file format is a general-purpose format developed by the Society of Exploration Geophysicists. The SEG-D format is a specialized format. In some embodiments, the seismic traces may be stored in a seismic data file as:

| Trace1 | Trace2 | . . . | TraceN |
|---|---|---|---|
| 0.1 | −0.1 | . . . | 0.2 |
| 0.3 | 0.2 | . . . | 0.4 |
| 0.5 | 0.4 | . . . | 0.6 |
| . | . | . | . |
| . | . | . | . |
| . | . | . | . |
| −0.1 | 0.1 | . . . | 0.1 |

In the oversimplified example of seismic traces stored within a seismic data file above, each column represents a seismic trace 1 through N as denoted by each header using a sequence of alphanumeric characters. Further, each row represents the discrete time determined by the sampling rate that a seismic receiver (106) detected and recorded the velocity of ground motion or pressure fluctuation caused by the seismic waves. Further still, each element represents the velocity of ground motion or pressure fluctuation at each discrete time for each seismic trace using numeric characters. Additional header information may also be included (not shown). The additional header information may be first values of the seismic survey geometry parameters. This “structure” of a seismic data file may also be considered metadata. The structure of a seismic data file may depend on the file format that stores the seismic data.

The alphanumeric and numeric characters within a seismic data file may be digitally organized and stored by an array of bytes. As the number of alphanumeric and numeric characters within a seismic data file increases, so does the number of bytes the seismic data file will be. As such, the number of bytes quantifies the size of a seismic data file. A seismic data file may be hundreds of gigabytes to tens of terabytes in size.

Seismic traces in a seismic data file may be processed to produce useful information about the subterranean region of interest (102). A processed seismic data file may also store seismic traces. Seismic processing may be used to attenuate artifacts and amplify manifestations of subterranean features. After processing, or at an intermediate point in processing, a seismic data file may be loaded into seismic interpretation software. The seismic interpretation software may then display the seismic traces in such a way that manifestations of subterranean features may be viewed, manipulated, and interpreted. The seismic interpretation software may be used to facilitate identifying a hydrocarbon reservoir (105). Hereinafter, a seismic data file may be a processed seismic data file.

However, a seismic data file in a predetermined file format may not be immediately loaded into seismic interpretation software. The seismic interpretation software may prefer or require conversion of a seismic data file from the predetermined file format to an alternate file format (hereinafter “destination file format”). For example, the seismic data file may be in an open-source file format, which may be widely used across the seismic industry, but the seismic interpretation software may require the seismic data file be in a proprietary file format. Specifically, the Petrel E&P software or future analogous software may prefer or require loading a seismic data file in a ZGY file format. Further, the HIS Kingdom software or future analogous software may prefer or require loading a seismic data file in a KSD file format.

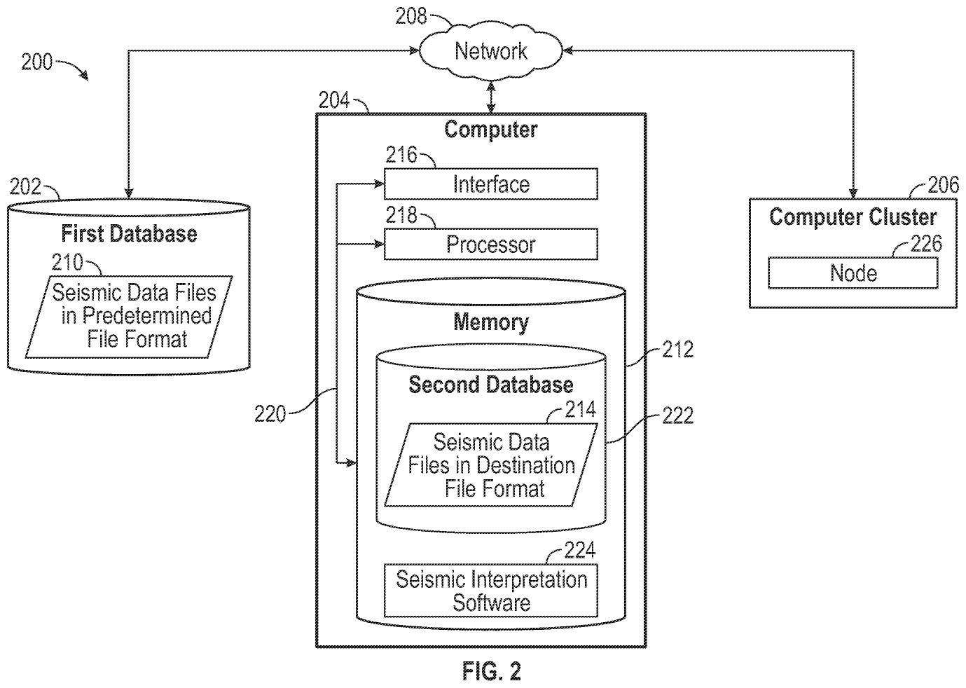

Conversion of a seismic data file from the predetermined file format to the destination file format may be performed within a computing environment. FIG. 2 illustrates a computing environment (200) in accordance with one or more embodiments. In general, the computing environment (200) is a collection of hardware and software able to receive, transmit, process, store, and/or manage seismic data files. The computing environment (200) may be a local, global, and/or cloud computing environment (200). The computing environment (200) may include one or more first databases (202), computers (204), and/or computer clusters (206) each of which may be used or accessed by one or more users sequentially or simultaneously. For illustration, FIG. 2 simply shows one first database (202), one computer (204), and one computer cluster (206). The first database (202), computer (204), and computer cluster (206) are communicably coupled with a network (208). In some embodiments, the computer (204) may act as a client and the computer cluster (206) may act as a server where the computer cluster (206) performs a service or task as requested by the computer (204) over the network (208).

In some embodiments, the first database (202) may store seismic data files in the predetermined file format (210). The first database (202) may organize the seismic data files in the predetermined file format (210) by assigning a unique identifier to each seismic data file in the predetermined file format (210). Each seismic data file in the predetermined file format (210) may be queried from the first database (202) using the identifier. The identifier may be a sequence of alphanumeric characters. In some embodiments, the identifier may be the file name of each seismic data file in the predetermined file format (210). In other embodiments, the identifier may be external to the name of each seismic data file in the predetermined file format (210). In some embodiments, the identifier may be unique to each seismic data file in the predetermined file format (210). In other embodiments, the identifier may be unique to each seismic data file in the predetermined file format (210) and all other files associated with each seismic data file.

Hereinafter, the identifier, file name, and file path of the seismic data file in the predetermined file format (210) may be referred to as metadata. In general, metadata is data that provides information about the seismic traces, ancillary data, and/or the seismic data file that stores the seismic traces and/or ancillary data but is not in and of itself the seismic traces or ancillary data stored in the seismic data file. In some embodiments, the metadata may be stored in a separate metadata file and the identifier associated to the metadata file.

Returning to FIG. 2, the computer (204) may include a memory (212), interface (216), and computer processor (218) among other components. The memory (212) may be separated into short-term memory known as random access memory (RAM) and long-term memory known as a hard drive. The components of the computer (204) communicate with one another using a system bus (220). The hard drive of the memory (212) may store a second database (222) and seismic interpretation software (224). While the components of the computer (204) are shown as single components, multiple components of any component may exist within the computer (204). Further, though not shown in FIG. 2, any component of the computer (204) may physically reside external to the computer (204).

The hard drive of the memory (212) permanently stores data. For example, seismic data files may be stored in a second database (222) that resides on the hard drive of the memory (212). The hard drive of the memory (212) may also store computer programs. Computer programs may include JAVA, C++, SQL, Python, and MATLAB among others (not shown). Computer programs may also include seismic interpretation software (224) and wellbore planning software (not shown). In some embodiments, a hard drive may be external to the computer (204) in the form of tape readers or high-capacity hard drives.

The RAM of the memory (212) temporarily stores data. The RAM may temporarily store data from the hard drive. For example, the RAM may temporarily store a seismic data file in the predetermined file format (210) while a computer program executes instructions to convert the seismic data file to the destination file format.

The interface (216) is a boundary that allows for the exchange of information. The interface (216) may be a hardware interface (216) and/or a software interface (216). The interface (216) may contain encoded logic such that information may be exchanged. For example, a screen, touchscreen, keyboard, mouse, and wand are all hardware interfaces (216) that allow for the exchange of information between components of the computer (204) and one or more users of the computer (204). Scripts written in computer programs are software interfaces (216) that allow for the exchange of information between components within the computer (204) and/or between components within the computing environment (200). A script may be a sequence of instructions that are executed by a computer program. In some embodiments, a script may generate a control file used to convert a seismic data file in the predetermined file format (210) to a seismic data file in the destination file format (214).

The computer processor (218) (hereinafter “processor”) may also execute instructions. The processor (218) may be one or more central processing units (CPU) and/or one or more graphics processing units (GPU).

In some embodiments, the computing environment (200) may further include a computer cluster (206). The computer cluster (206) may be a set of computers (204). As such, each computer (204) within the computer cluster (206) may include some, all, or more components relative to the previously described computer (204), such as a processor (218). Hereinafter, each computer (204) within the computer cluster (206) will be described as a node (226). The computer cluster (206) may be used to execute instructions contained within a script. Further, each node (226) may be executing the same instructions contained within the script but for a portion of a seismic data file simultaneously. This process may be referred to as “parallel computing” or “parallel processing.” Hereinafter, using the phrase “in parallel” refers to “parallel computing.”

Traditionally, manual conversion of a seismic data file in the predetermined file format (210) to a seismic data file in the destination file format (214) has been time consuming and prone to error. For example, it may be time consuming for a user to search for a seismic data file in the predetermined file format (210) within the first database (202). It may also be time consuming for the user to wait while the computer (204) transfers the seismic data file in the predetermined file format (210) to the second database (222). It may further be time consuming for the computer (204) to convert the seismic data file in the predetermined file format (210) to the seismic data file in the destination file format (214). Transfer and conversion may individually take on the order of hours. It may also be time consuming for a user to quality control the seismic data file before and/or after conversion. Lastly, manually selected metadata associated with the seismic data file may be erroneously selected by a user, such as the file name of the seismic data file in the destination file format (214) or the UTM zone. Erroneous selections may require one or more steps in the conversion process to be repeated. Even then, errors could remain and/or new errors could be introduced.

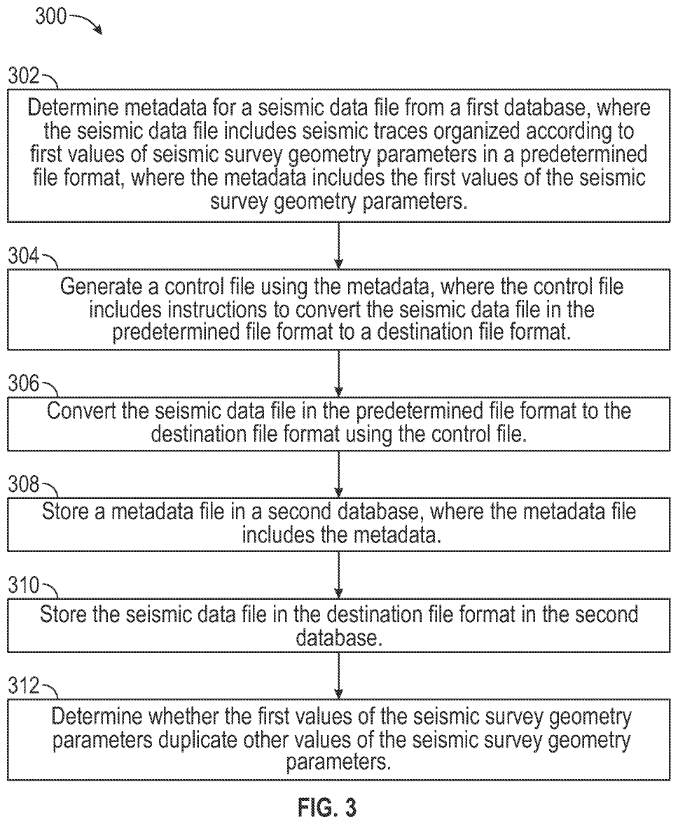

FIG. 3 illustrates a first method (300) to automatically convert a seismic data file in a predetermined file format (210) to a seismic data file in a destination file format (214) in accordance with one or more embodiments. The first method (300) may be automatically performed by a “data file format manager.” In some embodiments, the data file format manager may use part or all of the computing environment (200) to automatically perform the first method (300). For example, the data file format manager may use one or more scripts executed by one or more computer programs to perform the first method (300). A computer program may be stored on a computer (204) and/or a computer cluster (206). Further, the first method (300) may be performed for any number of processed seismic data files automatically with little-to-no prompting from a user. In some embodiments, the first method (300) may be performed for multiple seismic data files in series.

In step 302, metadata is determined for a seismic data file stored in a first database (202). In some embodiments, the first database (202) is separate from a computer (204) within a computing environment (200) as shown in FIG. 2. In other embodiments, the first database (202) is stored in a memory (212) of a computer (204) within the computing environment (200). The seismic data file may store seismic traces and/or ancillary data organized according to values of seismic survey geometry parameters as described in FIG. 1. Further, the seismic data file is in a predetermined file format. In some embodiments, the predetermined file format may be an SEG-Y file format or an SEG-D format. If the predetermined file format is the SEG-Y file format, the file name of the seismic data file may be an alphanumeric sequence followed by the extension “.segy”. In some embodiments, the metadata may include an identifier, a file name, a file path, a structure, and values of the seismic survey geometry parameters. In some embodiments, the metadata may be determined for a seismic data file stored in a first database (202) by querying the first database (202) using the identifier and scanning the header information within the seismic data file and/or scanning the first database (202) for information associated with the seismic data file.

In step 304, a control file is generated using the metadata. The control file may contain instructions to convert the seismic data file in the predetermined file format (210) to the seismic data file in a destination file format (214). In some embodiments, the control file contains the structure of the predetermined file format and the structure of the destination file format.

In step 306, the seismic data file in the predetermined file format (210) is converted to the seismic data file in the destination file format (214) using the control file. In some embodiments, the destination file format may be a ZGY file format. In some embodiments, portions of the seismic data file in the predetermined file format (210) may be converted to the destination file format in parallel using a computer cluster (206).

In step 308, a metadata file is stored in a second database (222). The metadata file stores the metadata. In some embodiments, the second database (222) may be located on a memory (212) on the computer (204) as shown in FIG. 2. In some embodiments, the second database (222) may be a database associated with the seismic interpretation software (224) and/or wellbore planning software. For example, the second database (222) may be a Petrel E&P software database or future analogous software database. In some embodiments, the identifier may be associated to the metadata file.

In step 310, the seismic data file in the destination file format (214) is stored in the second database (222). In some embodiments, the seismic data file in the destination file format (214) may be initially stored in a stage area prior to being stored in the second database (222). Further, the seismic data file in the destination file format (214) may be stored in a pre-existing folder within the second database (222) or in a new folder. Further, some metadata, such as the values of the seismic survey geometry parameters, may be registered to the second database (222) before and/or after the seismic data file in the destination file format (214) is stored in the second database (222). In some embodiments, the seismic data file in the destination file format (214) stored in the second database (222) is re-named following a standard file naming convention.

In step 312, first values of the seismic survey geometry parameters of the seismic data file in the destination file format (214) are compared to second values of the seismic survey geometry parameters of another seismic data file in the destination file format (214) located in the second database (222). A comparison is performed to determine if multiple seismic data files are from the same seismic survey and/or associated to the same subterranean region of interest (102). In some embodiments, the first values of the seismic survey geometry parameters of the seismic data file in the destination file format (214) are queried and compared. If another seismic data file for the same seismic survey or same subterranean region of interest (102) is found, the seismic data file in the destination file format (214) may be placed in the same folder as the other seismic data file for the same seismic survey or same subterranean region of interest (102). If another seismic data file for the same seismic survey or same subterranean region of interest (102) is not found, the seismic data file in the destination file format (214) may be placed in a new folder.

The first method (300) may reduce time consumption and error. Time consumption may be reduced as the user neither has to search for the seismic data file in the predetermined file format (210) in the first database (202) nor wait while the computer (204) transfers and converts the seismic data file in the predetermined file format (210). Time consumption may be further reduced as the computer cluster (206) is converting portions of the seismic data file in the predetermined file format (210) in parallel. Lastly, errors may be reduced as steps that traditionally require manual entries or determinations by the user are now automated.

Following the first method (300) described in FIG. 3, a second method (400) may be performed within seismic interpretation software (224), then wellbore planning software in accordance with one or more embodiments. In step 402, the seismic data file in the destination file format (214) in the second database (222) is loaded into seismic interpretation software (224). In some embodiments, loading may include using the first values of the seismic survey geometry parameters stored in the metadata file to display the seismic data file in the destination file format (214). In some embodiments, loading may also include adding comments about the history of the seismic data file in the destination file format (214). In some embodiments, if another seismic data file was found for the same seismic survey or same subterranean region of interest (102) as the seismic data file in the destination file format (214) as described in step 312, both seismic data files may be loaded into the seismic interpretation software (224).

In step 404, a user may interpret the seismic data file in the destination file format (214) using the seismic interpretation software (224) to identify the manifestation of a hydrocarbon reservoir (105). In some embodiments, if another seismic data file was found for the same seismic survey or same subterranean region of interest (102) as the seismic data file in the destination file format (214) as described in step 312, both seismic data files may be collectively interpreted to identify the manifestation of a hydrocarbon reservoir (105).

In step 406, the user may determine a wellbore path that intersects the hydrocarbon reservoir (105) within the subterranean region of interest (102) using the wellbore planning software.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
determining, by a computer processor, first metadata for a first seismic data file from a first database, wherein the first seismic data file comprises a first plurality of seismic traces organized according to first values of a first plurality of seismic survey geometry parameters in a predetermined file format, wherein the first metadata comprises the first values of the first plurality of seismic survey geometry parameters;
generating, by the computer processor, a control file using the first metadata, wherein the control file comprises instructions to convert the first seismic data file in the predetermined file format to a destination file format;
converting, by the computer processor, the first seismic data file in the predetermined file format to the destination file format using the control file;
storing, by the computer processor, a first metadata file in a second database, wherein the first metadata file comprises the first metadata;
storing, by the computer processor, the first seismic data file in the destination file format in the second database; and
determining, by the computer processor, whether the first values of the first plurality of seismic survey geometry parameters duplicate second values of the first plurality of seismic survey geometry parameters.

2. The method of claim 1, further comprising:
loading the first seismic data file in the destination file format using the first values of the first plurality of seismic survey geometry parameters;
identifying a hydrocarbon reservoir by, at least in part, interpreting the first seismic data file in the destination file format; and
determining a wellbore path that intersects the hydrocarbon reservoir.

3. The method of claim 1, wherein the method is automatically repeated for a plurality of seismic data files from the first database.

4. The method of claim 1, further comprising:
loading the first seismic data file in the destination file format and a second seismic data file in the destination file format when the first values of the first plurality of seismic survey geometry parameters duplicate the second values of the first plurality of seismic survey geometry parameters, wherein the second seismic data file comprises a second plurality of seismic traces organized according to the second values of the first plurality of seismic survey geometry parameters;
identifying a hydrocarbon reservoir by, at least in part, interpreting the first seismic data file in the destination file format and the second seismic data file in the destination file format; and
determining a wellbore path that intersects the hydrocarbon reservoir.

5. The method of claim 1, wherein a computer cluster comprises the computer processor.

6. The method of claim 1, wherein the computer processor comprises a graphics processing unit (GPU).

7. The method of claim 1, wherein the predetermined file format is an SEG-Y file format.

8. The method of claim 1, wherein the destination file format is a ZGY file format.

9. The method of claim 1, wherein a second metadata file comprises second metadata, wherein the second metadata comprises the second values of the first plurality of seismic survey geometry parameters.

10. The method of claim 1, wherein storing the first seismic data file in the destination file format in the second database further comprises:
determining a file name for the first seismic data file in the destination file format;
determining a file path for the first seismic data file in the destination file format; and
determining a coordinate system for the first seismic data file in the destination file format using the first values of the first plurality of seismic survey geometry parameters.

11. A system, comprising:
a data file format manager comprising a computer processor, wherein the data file format manager is configured to:
determine first metadata for a first seismic data file from a first database, wherein the first seismic data file comprises a first plurality of seismic traces organized according to first values of a first plurality of seismic survey geometry parameters in a predetermined file format, wherein the first metadata comprises the first values of the first plurality of seismic survey geometry parameters,
generate a control file using the first metadata, wherein the control file comprises instructions to convert the first seismic data file in the predetermined file format to a destination file format,
convert the first seismic data file in the predetermined file format to the destination file format using the control file,
store a first metadata file in a second database, wherein the first metadata file comprises the first metadata,
store the first seismic data file in the destination file format in the second database, and
determine whether the first values of the first plurality of seismic survey geometry parameters duplicate second values of the first plurality of seismic survey geometry parameters.

12. The system of claim 11, wherein the data file format manager comprises a computer cluster, wherein the computer cluster comprises the computer processor.

13. The system of claim 11, wherein the computer processor comprises a graphics processing unit (GPU).

14. The system of claim 11, further comprising a computer program located on a memory.

15. The system of claim 11, further comprising:
seismic interpretation software located on a memory coupled to the computer processor, wherein the seismic interpretation software is configured to:
load the first seismic data file in the destination file format using the first values of the first plurality of seismic survey geometry parameters, and
identify, at least in part, a hydrocarbon reservoir by interpreting the first seismic data file in the destination file format.

16. The system of claim 15, further comprising:
wellbore planning software located on the memory coupled to the computer processor, wherein the wellbore planning software is configured to determine a wellbore path that intersects the hydrocarbon reservoir.

17. The system of claim 11, further comprising:
seismic interpretation software located on a memory coupled to the computer processor, wherein the seismic interpretation software is configured to:
load the first seismic data file in the destination file format and a second seismic data file in the destination file format when the first values of the first plurality of seismic survey geometry parameters duplicate the second values of the first plurality of seismic survey geometry parameters, wherein the second seismic data file comprises a second plurality of seismic traces organized according to the second values of the first plurality of seismic survey geometry parameters, and
identify a hydrocarbon reservoir by, at least in part, interpreting the first seismic data file in the destination file format and the second seismic data file in the destination file format.

18. The system of claim 11, further comprising a seismic surveying system configured to generate the first seismic data file.

19. The system of claim 11, wherein the data file format manager configured to store the first seismic data file in the destination file format in the second database is further configured to:
determine a file name for the first seismic data file in the destination file format;
determine a file path for the first seismic data file in the destination file format; and
determine a coordinate system for the first seismic data file in the destination file format using the first values of the first plurality of seismic survey geometry parameters.

20. The system of claim 11, wherein a second metadata file comprises second metadata, wherein the second metadata comprises the second values of the first plurality of seismic survey geometry parameters.
